(19) United States
(12) Patent Application Publication
(10) Pub. No.: US 2010/0162382 A1
(43) Pub. Date: Jun. 24, 2010

(54) PACKET PROCESSING METHOD AND TOE HARDWARE

(75) Inventors: Sun Wook Kim, Hwaseong-si (KR); Seong Woon Kim, Gyeryong-si (KR); Han Namgoong, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/553,799

(22) Filed: Sep. 3, 2009

(30) Foreign Application Priority Data
Dec. 22, 2008 (KR) 10-2008-0131746

(51) Int. Cl. G06F 17/00; G06F 11/00

(52) U.S. Cl. 726/13; 726/11; 726/23

(57) ABSTRACT

Provided is a TOE hardware which includes intrusion prevention system hardware for inspection and real-time interrupt against static/dynamic attacks over network as well as fast TCP/IP processing, and a packet processing method in the TOE hardware. When a network packet is received, it is segmented to extract a header and a payload. A pattern matching inspection is performed for the payload, and the payload passed the inspection is transferred to the host. For the header, a header inspection is performed and a TCP/IP processing is performed on the header passed the inspection. Processing on the payload is performed in parallel with processing on the header. Accordingly, the packet processing speed of the TOE hardware increases.

### CROSS-REFERENCE TO RELATED APPLICATIONS

This application claims priority under 35 U.S.C. §119 to Korean Patent Application No. 10-2008-0131746, filed on Dec. 22, 2008, in the Korean Intellectual Property Office, the disclosure of which is incorporated herein by reference in its entirety.

### TECHNICAL FIELD

The following disclosure relates to a packet processing method that includes receiving a packet to extract a header and a payload; performing pattern matching inspection on the payload, and transferring the payload passed the pattern matching inspection to a host; performing header inspection for determining whether the packet is an intrusion packet and Transmission Control Protocol/Internet Protocol (TCP/IP) processing on the header.

### BACKGROUND

With advances in network technologies and the rapid proliferation of the Internet, Ethernet technology, which is widely used in Local Area Networks (LAN) and Wide Area Networks (WAN), has surpassed the 1 Gigabit per second (Gbps) bandwidth mark to realize 10 Gigabit Ethernet capability that provides 10 Gbps bandwidth.

TCP/IP, which is widely used in Ethernet, is usually processed by a host processor, but the resulting load on the host processor degrades entire system performance.

As network speeds progress beyond single Gigabit-level Ethernet to 10 Gigabit Ethernet and beyond, host processors use more processing power for processing TCP/IP stacks than performing actual tasks.

That is, when network speed exceeds TCP/IP processing capacity of a processor, it decreases computer processing speed and causes network bottlenecks.

TCP/IP offload technology has been proposed as a solution, which enhances system performance by decreasing load on a host processor by processing TCP/IP with dedicated hardware instead of the host processor.

TOE hardware that applies TCP/IP offload technology is now in an initial development stage, and is predicted to have a continuously increasing market demand in Internet fields and storage fields.

The speeding up of networks and the rapid proliferation of the Internet vitalize electronic transactions and all forms of information transferring/providing services such as e-commerce and e-mail. Thus, attempts at intrusion through networks continue to increase over time. Moreover, crimes over the Internet—for example, the dissemination of harmful data such as viruses and the unauthorized use of information that is obtained through illegal intrusions—are also rapidly increasing.

Accordingly, as network speeds become faster at a rapid pace and the Internet becomes more widely available, a method is required which quickly processes TCP/IP and effectively prevents intrusions that are made through networks.

### SUMMARY

In one general aspect, a packet processing method in a TOE hardware includes: receiving a packet to extract a header and a payload; performing pattern matching inspection on the payload, and transferring the payload passed the pattern matching inspection to a host; performing header inspection for determining whether the packet is an intrusion packet and TCP/IP processing on the header.

In the packet processing method, the performing of pattern matching inspection may include: determining whether the payload is a payload of a single packet or a payload of a segment packet; performing the pattern matching inspection when the payload is the payload of the single packet; and reassembling the segment packet to perform the pattern matching inspection when the payload is the payload of the segment packet.

In the packet processing method, the reassembling of the segment packet may include: performing IP protocol processing to reassemble the segment packet, when the segment packet is an IP segment packet; and performing transport protocol processing to reassemble the segment packet, when the segment packet is a TCP segment packet.

In the packet processing method, the pattern matching inspection on the payload of the TCP segment packet may be performed when a size of the payload by the packet reassembly is greater than a reference value.

In the packet processing method, when the packet is determined as an intrusion packet, the payload may be deleted, information of the packet may be stored, and the stored packet information may be transmitted to the host at certain intervals.

In the packet processing method, the TOE hardware may receive a new signature from the host at certain intervals.

In the packet processing method, the header inspection may include Access Control List (ACL) inspection which determines whether a node transmitting the packet is included in an ACL, and signature inspection which determines whether a signature of a stored attack packet is matched with a pattern of the header, and the TCP/IP processing may include IP protocol processing and transport protocol processing on the header passed the ACL inspection and the signature inspection.

In the packet processing method, the header inspection may further include session inspection on the IP protocol-processed header, and the transport protocol processing may be performed on the header passed the session inspection.

In the packet processing method, the session inspection may inspect whether the packet is a packet which is received from a normally-connected socket based on comparison with stored socket information.

In the packet processing method, the session inspection may inspect whether a session bandwidth of the packet is within a reference value.

In the packet processing method, when the received packet is determined as an intrusion packet, the packet may be deleted, information of the packet may be stored, and the stored packet information may be transferred to the host at certain intervals.

In another general aspect, a TOE hardware includes: a header extractor extracting a header and a payload of a received packet; a payload processor processing the extracted payload; a header inspector inspecting the extracted header; and a TCP/IP processor performing TCP/IP processing on the header.

In the TOE hardware, the payload processor may include a payload pattern matching engine performing pattern matching inspection on a payload. The TCP/IP processor may include: a payload storage storing a received payload; and an interrupt packet information storage storing information of a packet which is determined as an intrusion packet. Herein, the payload pattern matching engine may perform the pattern matching inspection on the payload which is stored in the payload storage. When the payload is determined as a payload of an intrusion packet, the payload pattern matching engine may store information of the intrusion packet in the interrupt packet information storage. When the payload is not the payload of the intrusion packet, the payload pattern matching engine may transfer the payload to a host.

In the TOE hardware, when the received packet is an IP segment packet, the TCP/IP processor may store a payload of the segment packet in the payload storage, perform IP protocol processing on a header of the segment packet and reassemble the payload of the segment packet, and the payload processor may perform pattern matching inspection on the reassembled payload.

In the TOE hardware, when the received packet is a TCP segment packet, the TCP/IP processor may store a payload of the segment packet in the payload storage, perform transport protocol processing on a header of the segment packet and reassemble the payload of the segment packet, and the payload processor may perform the pattern matching inspection on the reassembled payload.

In the TOE hardware, the payload processor may perform the pattern matching inspection when a size of the reassembled payload is greater than a reference value.

In the TOE hardware, the TCP/IP processor may include an interrupt packet information storage storing information of a packet which is determined as an intrusion packet, and the header inspector may include: an ACL storage storing an ACL; a signature storage storing a signature which is received from a host at certain intervals; an ACL inspector inspecting whether the header is included in the ACL; and a signature matching inspector inspecting whether to match with the signature on the header. Herein, when the header is determined as a header of an intrusion packet, the ACL inspector and the signature matching inspector may store information of the intrusion packet in the interrupt packet information storage, and when the header is not the header of the intrusion packet, the ACL inspector and the signature matching inspector may transfer the header to the TCP/IP processor.

In the TOE hardware, the header inspector may further include a session inspector performing session inspection on a header, wherein the session inspector may inspect whether the packet is a packet which is received from a normally-connected socket or whether a session bandwidth of the packet is within a reference value, on a header in which IP protocol processing is performed by the TCP/IP processor, and the TCP/IP processor may perform transport protocol processing on a header passed the session inspection.

In the TOE hardware, the interrupt packet information storage may transfer information of a stored interrupt packet to a host at certain intervals.

Other features and aspects will be apparent from the following detailed description, the drawings, and the claims.

### BRIEF DESCRIPTION OF THE DRAWINGS

FIG. 1 is a block diagram schematically illustrating the configuration of a TOE hardware.

FIG. 2 is a block diagram schematically illustrating the configuration of a TOE hardware for preventing intrusions made through networks, according to an exemplary embodiment.

FIG. 3 is a flowchart schematically illustrating a method for processing a received packet in the TOE hardware according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Exemplary embodiments relates to a TOE hardware which includes an intrusion prevention system hardware for inspection and real-time interrupt against static/dynamic attacks on network traffic, and to a network packet processing method using the same.

A packet processing method in a TOE hardware according to exemplary embodiments can quickly perform network protocol/data transmission processing based on an existing operating system (OS) as well as network intrusion prevention. Accordingly, by applying the TOE hardware according to exemplary embodiments instead of a network card to a server that is connected to a network, network application programs can be operated and intrusions that are made through networks can be prevented.

TOE Hardware

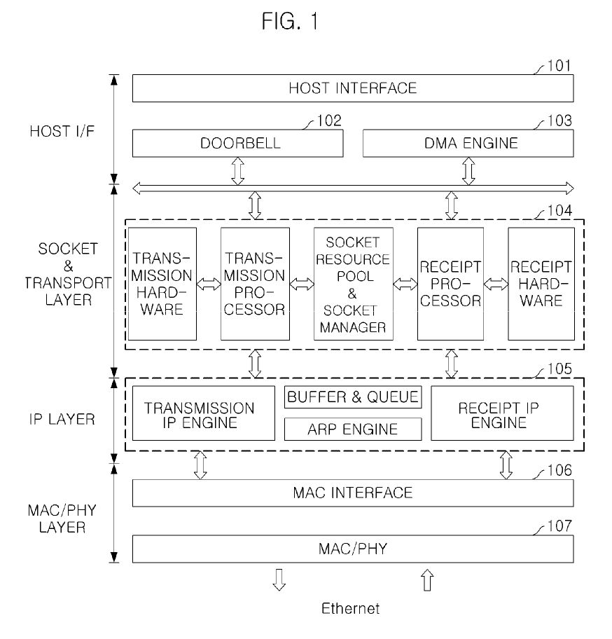

As illustrated in FIG. 1, a TOE hardware quickly performs TCP/IP process between a host processor and a high-speed network such as gigabit-level Ethernet.

The TOE hardware includes a Media Access Control/Physical (MAC/PHY) layer, an IP layer 105, a socket/transport layer 104, and a host interface (host I/F). The MAC/PHY layer includes an MAC/PHY module 107 and an MAC interface 106. The IP layer 105 includes a transmission IP engine, a buffer/queue, an Address Resolution Protocol (ARP) engine and a receipt IP engine. The socket/transport layer 104 includes a transmission hardware, a transmission processor, a socket resource pool/socket manager, a receipt processor and a receipt hardware. The host I/F includes a doorbell 102, a Direct Memory Access (DMA) engine 103 and a host interface 101.

TCP/IP processing is performed on a network packet that is received thought the MAC/PHY layer, and the TCP/IP-processed network packet is transferred to a host.

TCP/IP Processor

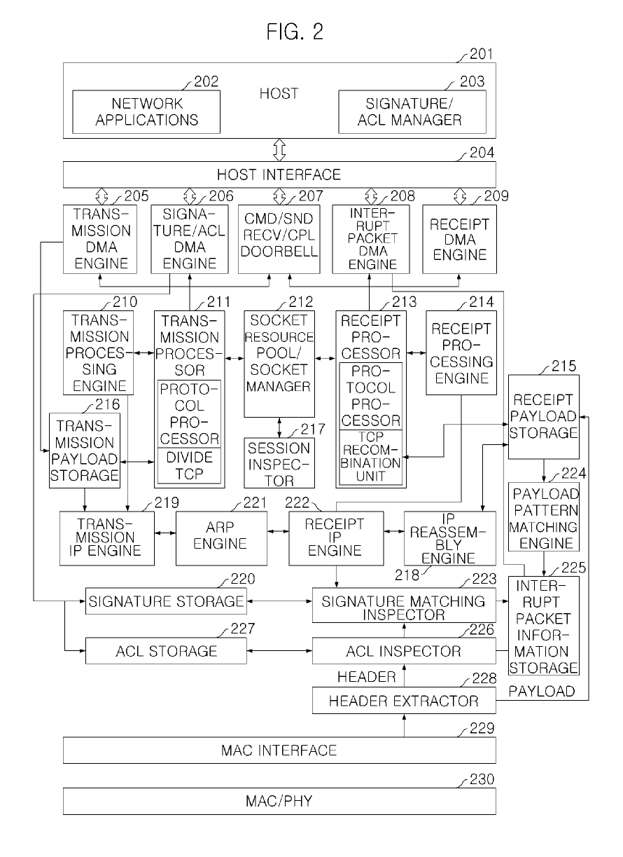

FIG. 2 is a block diagram schematically illustrating a TOE hardware to which necessary elements are added for preventing intrusions that are made through networks, according to an exemplary embodiment.

Network protocol processing, socket resource control command and TCP connection/disconnection command processing, generation and transmission of processing result information based on each command, receipt control of network packets, storage of socket information and packet transmission information are performed in the TCP/IP processor of the TOE hardware.

The TCP/IP processor includes a transmission processor 211, a receipt processor 213, command/send/receipt/completion (CMD/SND/RECV/CPL) doorbells 207, a receipt payload storage 215, a socket resource pool/socket manager 212, a transmission DMA engine 205, a receipt DMA engine 209, a transmission processing engine 210, a receipt processing engine 214, a transmission payload storage 216, a transmission IP engine 219, a receipt IP engine 222, an IP reassembly engine 218, an ARP engine 221, an MAC interface 229, a gigabyte MAC/PHY module 230, an interrupt packet information storage 225. TCP/IP processing is performed on a received packet by the TCP/IP processor, and the TCP/IP-processed packet is transferred to a host 201.

The host 201 includes network applications 202 and a signature/ACL manager. The network applications 202 drives network protocol stacks. The signature/ACL manager 203 receives socket/data transmission/receipt command to transfer to the TOE hardware, generates a signature for preventing intrusions, and collects ACL and interrupt packet information from the TOE hardware and manages the collected ACL and interrupt packet information.

The transmission processor 211 of the TOE hardware processes network transmission protocols, and segments transmission data. The receipt processor 213 processes the protocol of a received packet, and when the received packet is a TCP segment packet, the transmission processor 211 reassembles the received packet.

The command/send/receipt/completion doorbells 207 store the transmission of a socket generation/deletion command, an attribute change command and a TCP connection/disconnection command which are transferred from the host 201, the transmission of network protocol-based message transmission/receipt command in which a network application program requests on a generated socket, and the transmission of a processing result based on each command.

The receipt payload storage 215 stores the payload data of a packet that is received from the outside.

The socket resource pool/socket manager 212 stores and manages information of a generated socket according to the control of the transmission processor 211 and the receipt processor 213.

The transmission DMA engine 205 directly transmits the transmission data of the network application 202 to the TOE hardware without copying them by an operating system (OS). The receipt DMA engine 209 directly transmits the data received through the TOE hardware to the network application 202 without copying them by the OS.

The transmission processing engine 210 and the receipt processing engine 214 transmit/receive the header and data of a corresponding protocol. The transmission payload storage 216 stores a transmission payload data that is transmitted from the host 201. The transmission IP engine 219 and the receipt IP engine 222 transmit/receive and process an IP header.

When a received packet is an IP segment packet, the IP reassembly engine 218 reassembles the IP segment packet. An ARP engine 221 transmits/receives and processes an ARP packet.

The MAC interface 229 and the MAC/PHY module 230 transmit/receive data to/from external networks such as gigabit Ethernet.

The interrupt packet information storage 225 stores information of packets that are determined as an intrusion packet and thereby interrupted. The interrupt packet information storage 225 transmits corresponding information to the host 201 at certain intervals.

Elements for Preventing Intrusions Which are Made Through Networks

Elements for preventing intrusions which are made through networks include a header extractor, a header inspector and a payload processor. The header extractor extracts a header and a payload from a packet. The header inspector inspects the extracted header. The payload processor checks the extracted payload and transfers the checked payload to the host 201.

The header extractor 228 segments a received packet into a header and a payload.

The header inspector 228 includes an ACL inspector 226, an ACL storage 227, a signature matching inspector 223, a signature storage 220, and a session inspector 217.

The ACL storage 227 stores an ACL having information that includes the IP address of a node to which access is allowed and the IP address of a node to which access is denied. The ACL inspector 226 inspects whether a received packet is a packet from a node to which access is allowed, based on the IP address of an extracted header.

The signature storage 220 stores the signatures of intrusion packets. By matching the signature of the received packet with the signature of the intrusion packet stored in the signature storage 220 based on a header, the signature matching inspector 223 determines whether a received packet is the intrusion packet.

The session inspector 217 performs an inspection on an abnormal session, i.e., whether a received packet is received from a normally-connected socket. Moreover, the session inspector 217 inspects whether the session bandwidth of the received packet is within a reference value. The session inspector 217 inspects a bandwidth of a session and whether a session is normal, and thus, more accurately determines whether the received packet is an intrusion packet.

A signature/ACL DMA engine 206 transmits a signature and an ACL that are managed by the signature/ACL manager 203 of the host 201. An interrupt packet DMA engine 208 transmits the information of a received intrusion packet to the signature/ACL manager 203.

Packet Processing Method

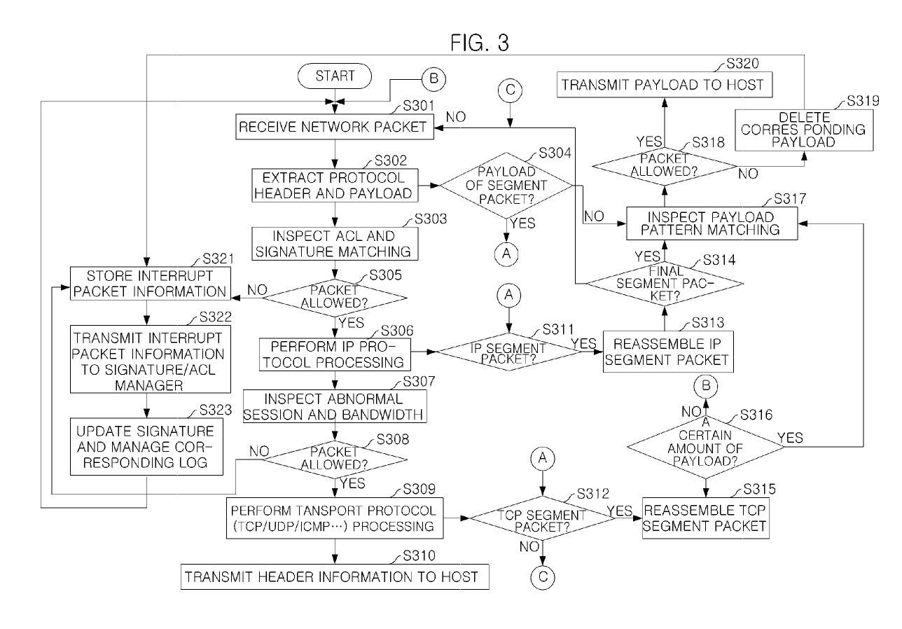

FIG. 3 is a flowchart schematically illustrating a method for processing a received packet in the TOE hardware according to an exemplary embodiment.

The TOE hardware receives a network packet through the MAC interface 229 in operation S301. The header extractor 228 segments the received packet into a header and a payload to extract the header and the payload in operation S302.

The TOE hardware performs ACL inspection and signature matching inspection, on the extracted header in operation S303. In the ACL inspection, the ACL inspector 226 inspects whether a node transmitting the received packet is included in the ACL which is stored in the ACL storage 227 to determine whether a corresponding packet is an intrusion packet.

In the signature matching inspection, based on the signature of the intrusion packet that is stored in the signature storage 220, the signature matching inspector 223 performs pattern matching on the header of the received packet to determine whether the corresponding packet is the intrusion packet.

Based on the ACL inspection and the signature matching inspection, the TOE hardware determines whether to allow the corresponding packet in operation S305.

When the determination result shows that the received packet is the intrusion packet, the TOE hardware deletes the corresponding packet, and stores the information of the corresponding packet in the interrupt packet information storage 225 in operation S321. The stored interrupt packet information is transmitted to the host 201 at certain intervals in operation S322. The interrupt packet DMA engine 208 transfers the interrupt packet information to the signature/ACL manager 203 through the host interface 204.

The signature/ACL manager 203 generates a new signature at certain intervals based on the collected intrusion packet information, and transmits the newly generated signature to the signature storage 220 through the signature/ACL DMA engine 206. The signature storage 220 updates signature information and manages a corresponding log on the basis of the received signature in operation S323.

When the determination result shows that the received packet is not the intrusion packet based on the ACL inspection and the signature matching inspection, the TOE hardware performs TCP/IP processing on the basis of the extracted header.

Based on a header which is passed in the ACL inspection and the signature matching inspection, the receipt IP engine 222 processes an IP protocol in operation S306.

At this point, on the header of a packet in which the processing of the IP protocol is completed, the TOE hardware may perform session inspection based on the information of a socket that is stored in the socket resource pool/socket manager 212 in operation S307.

In the session inspection, the session inspector 217 may inspect whether a corresponding packet is a packet which is received from a normal session, i.e., a normally-connected socket and/or whether a bandwidth of the corresponding is used excessively over a reference value.

Based on a result of the session inspection, the TOE hardware determines whether to allow the corresponding packet in operation S308.

When the session is determined to be abnormal or using its bandwidth greater than the reference value, the TOE hardware determines the corresponding packet as an intrusion packet.

When the determination result shows that the corresponding packet is the intrusion packet, the TOE hardware performs operations S321 to S323 in which the interrupt packet information is processed.

When the determination result shows that the corresponding packet is not the intrusion packet, the TOE hardware performs transport protocol processing on the corresponding packet through the receipt processor 213 in operation S309.

The receipt processor 213 transfers header information, in which transport protocol processing is completed, to the host 201 in operation S310.

Processing on the payload (which is extracted in the header extractor 228) is performed in parallel with processing on a header. Accordingly, the TOE hardware increases its packet processing speed.

The extracted payload is stored in the receipt payload storage 215, and the TOE hardware first determines whether a corresponding payload is the payload of a segment packet in operation S304.

When the corresponding payload is not the payload of the segment packet, i.e., when the corresponding payload is determined as the payload of a single packet, the TOE hardware performs matching inspection on a payload pattern in operation S317.

When the corresponding packet is the segment packet, the TOE hardware determines whether the corresponding packet is an IP segment packet in operation S311. When the corresponding packet is determined as the IP segment packet, the TOE hardware performs IP protocol processing in operation S306, and reassembles the IP segment packet through the IP reassembly engine 218 in operation S313.

The IP segment packet is abused to transmit the intrusion data without being interrupted by segmenting and transmitting the intrusion data using the fact that the pattern matching of an intrusion prevention system is performed by packet unit.

When a final segment packet is received in operation S314, the payload pattern matching engine 224 performs payload pattern inspection on a corresponding payload in which IP reassembly is completed in operation S317.

When the corresponding packet is a packet in which TCP segment processing is completed, transport protocol processing is performed in operation S309, and the receipt processor 213 performs TCP reassembly processing in operation S315. Then, the payload pattern matching engine 224 inspects payload pattern matching in operation S317.

At this point, the TOE hardware determines whether the reassembled payload is more than a reference amount in operation S316. Only when the payload more than the reference amount is reassembled, the TOE hardware may perform pattern inspection on the payload.

Based on a result of the pattern matching inspection which is performed on the payload in operation S317, the TOE hardware determines whether to allow a packet in operation S318.

When the determination result shows that the payload is not the payload of the intrusion packet, the payload is transmitted to the host 201 in operation S320. The receipt DMA engine 209 transmits the payload to the network application 202 without copying the corresponding payload through the OS.

When the corresponding packet is determined to be the intrusion packet as a result of the payload pattern matching inspection in operation S317, the TOE hardware deletes the corresponding payload from the receipt payload storage 215, and performs operations S321 to S322 in which the interrupt packet information is processed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A packet processing method in a Transmission Control Protocol/Internet Protocol (TCP/IP) Offload Engine (TOE) hardware, the packet processing method comprising:
receiving a packet to extract a header and a payload;
performing pattern matching inspection on the payload, and transferring the payload passed the pattern matching inspection to a host; and
performing header inspection, for determining whether the packet is an intrusion packet, and TCP/IP processing on the header.

2. The packet processing method of claim 1, wherein the performing of pattern matching inspection comprises:
determining whether the payload is a payload of a single packet or a payload of a segment packet;
performing the pattern matching inspection when the payload is the payload of the single packet; and
reassembling the segment packet to perform the pattern matching inspection when the payload is the payload of the segment packet.

3. The packet processing method of claim 2, wherein the reassembling of the segment packet comprises:
performing IP protocol processing to reassemble the segment packet, when the segment packet is an IP segment packet; and
performing transport protocol processing to reassemble the segment packet, when the segment packet is a TCP segment packet.

4. The packet processing method of claim 3, wherein the pattern matching inspection on the payload of the TCP segment packet is performed when a size of the payload by the reassembly is greater than a reference value.

5. The packet processing method of claim 2, wherein when the packet is determined as an intrusion packet,
deleting the payload,
storing information on the packet, and
transmitting the stored packet information to the host at certain intervals.

6. The packet processing method of claim 5, wherein a new signature is received from the host at certain intervals.

7. The packet processing method of claim 1, wherein the header inspection comprises Access Control List (ACL) inspection which determines whether a node transmitting the packet is comprised in an ACL, and signature inspection which determines whether a signature of a stored attack packet is matched with a pattern of the header, and
the TCP/IP processing comprises IP protocol processing and transport protocol processing on the header passed the ACL inspection and the signature inspection.

8. The packet processing method of claim 7, wherein the header inspection further comprises session inspection on the IP protocol-processed header, and
the transport protocol processing is performed on the header passed the session inspection.

9. The packet processing method of claim 8, wherein the session inspection is inspecting whether the packet is a packet received from a normally-connected socket based on comparison with stored socket information.

10. The packet processing method of claim 8, wherein the session inspection is inspecting whether a session bandwidth of the packet is within a reference value.

11. The packet processing method of claim 7, wherein when the received packet is determined as an intrusion packet,
deleting the packet,
storing information of the packet, and
transferring the stored packet information to the host at certain intervals.

12. The packet processing method of claim 11, wherein a new signature is received from the host at certain intervals.

13. A Transmission Control Protocol/Internet Protocol (TCP/IP) Offload Engine (TOE) hardware, comprising:
a header extractor extracting a header and a payload of a received packet;
a payload processor processing the extracted payload;
a header inspector inspecting the extracted header; and
a TCP/IP processor performing TCP/IP processing on the header.

14. The TOE hardware of claim 13, wherein:
the payload processor comprises a payload pattern matching engine performing pattern matching inspection on a payload, and
the TCP/IP processor comprises:
a payload storage storing a received payload; and
an interrupt packet information storage storing information of a packet which is determined as an intrusion packet,
wherein:
the payload pattern matching engine performs the pattern matching inspection on the payload which is stored in the payload storage,
when the payload is determined as a payload of an intrusion packet, the payload pattern matching engine stores information of the intrusion packet in the interrupt packet information storage, and
when the payload is not the payload of the intrusion packet, the payload pattern matching engine transfers the payload to a host.

15. The TOE hardware of claim 14, wherein when the received packet is an IP segment packet,
the TCP/IP processor stores a payload of the segment packet in the payload storage, performs IP protocol processing on a header of the segment packet, and reassembles the payload of the segment packet, and
the payload processor performs pattern matching inspection on the reassembled payload.

16. The TOE hardware of claim 14, wherein when the received packet is a TCP segment packet,
the TCP/IP processor stores a payload of the segment packet in the payload storage, performs transport protocol processing on a header of the segment packet, and reassembles the payload of the segment packet, and
the payload processor performs the pattern matching inspection on the reassembled payload.

17. The TOE hardware of claim 16, wherein the payload processor performs the pattern matching inspection when a size of the reassembled payload is greater than a reference value.

18. The TOE hardware of claim 13, wherein:
the TCP/IP processor comprises an interrupt packet information storage storing information of a packet which is determined as an intrusion packet, and
the header inspector comprises:
an Access Control List (ACL) storage storing an ACL;
a signature storage storing a signature which is received from a host at certain intervals;
an ACL inspector inspecting whether the header is included in the ACL; and
a signature matching inspector inspecting whether to match with the signature on the header,
wherein:
when the header is determined as a header of an intrusion packet, the ACL inspector and the signature matching inspector store information of the intrusion packet in the interrupt packet information storage, and
when the header is not the header of the intrusion packet, the ACL inspector and the signature matching inspector transfer the header to the TCP/IP processor.

19. The TOE hardware of claim 18, wherein:
the header inspector further comprises a session inspector performing session inspection on a header,
wherein the session inspector inspects whether the packet is a packet received from a normally-connected socket or whether a session bandwidth of the packet is within a reference value, on a header in which IP protocol processing is performed by the TCP/IP processor, and
the TCP/IP processor performs transport protocol processing on a header passed the session inspection.

20. The TOE hardware of any one of claims 14, wherein the interrupt packet information storage transfers information of a stored interrupt packet to a host at certain intervals.
